(19) United States
(12) Patent Application Publication
(10) Pub. No.: US 2023/0162368 A1
(43) Pub. Date: May 25, 2023

(54) METHOD AND SYSTEM FOR OPTIMIZING SAMPLING IN SPOT TIME-OF-FLIGHT (TOF) SENSOR

(71) Applicant: SAMSUNG ELECTRONICS CO.,LTD., Suwon-si (KR)

(72) Inventors: Srenivas VARADARAJAN, Bengaluru (IN); Kaustav Chanda, Bengaluru (IN); Kwanghyuk Bae, Seoul (KR); Manish Goel, Bengaluru (IN)

(73) Assignee: SAMSUNG ELECTRONICS CO., LTD., Suwon-si (KR)

(21) Appl. No.: 17/992,296

(22) Filed: Nov. 22, 2022

(30) Foreign Application Priority Data
Nov. 24, 2021 (IN) 202141054242

(51) Int. Cl. G06T 7/12; G01S 17/894; G06T 17/00; G06T 7/521

(52) U.S. Cl. CPC G06T 7/12; G01S 17/894; G06T 17/00; G06T 7/521; G06T 2207/20021; G06T 2200/08; G06T 2207/20068; G06T 2207/10028

(57) ABSTRACT

A method for optimizing sampling in a spot Time-of-Flight (ToF) sensor includes receiving an image of a scene, dividing the image into plural rectangular regions, based on an edge feature in the image, computing an edge region alignment for each rectangular region by analyzing a Histogram of oriented Gradients (HoG) distribution corresponding to the rectangular region, re-projecting ToF data on a Complementary Metal Oxide Semiconductor (CMOS) Image Sensor (CIS) image plane according to the edge region alignment, sampling one or more rectangular regions from among the plural rectangular regions by comparing a regional depth variance of each rectangular region with a threshold depth variance, and reconfiguring an illumination pattern for a spot ToF sensor image frame using the one or more rectangular regions that are sampled.

### CROSS-REFERENCE TO RELATED APPLICATION

The present application claims priority to Indian Application No. 202141054242 filed on Nov. 24, 2021 in the Indian Patent Office, the contents of which are incorporated herein by reference in its entirety.

### BACKGROUND

The present disclosure relates, in general, to a spot Time of Flight (ToF) sensor, and more particularly but not exclusively to a method and a system for optimizing sampling in a spot ToF sensor using Complementary Metal-Oxide-Semiconductor CMOS Image Sensor (CIS) data.

A Time-of-Flight (ToF) sensor that generates high-resolution depth inferences at a group of sample locations is known as a Spot-ToF sensor. Spot ToF employs high-power LASER beams for active depth sensing, depth is computed by measuring a difference in time or phase between emitted and received light. Spot ToF includes a full resolution indirect flood ToF depth sensor in front of a specific module along with a spot ToF module.

However, Spot ToF has some disadvantages. For example, low-density sampling may result in the loss of 3D structures. On the other hand, uniform high-density sampling may necessitate substantial power, which is not available on portable devices. Also, a sample pattern is not based on near regional depth discontinuities, which is required for successful 3D reconstruction.

One approach to addressing these disadvantages uses Intelligent Detection and Ranging (iDAR), wherein a dynamic or adaptive Light Detection and Ranging (LiDAR) with a variable illumination pattern is used. Here, information from a High Definition (HD) camera is utilized for adaptive 3D sensing using LiDAR signals. Also, Deep Neural Network (DNN) is used to map scene structure to an illumination pattern. However, such an approach requires a higher power-consuming DNN, running on compute-intensive Graphics Processing Units (GPU) to infer a rough scene structure and an illuminating pattern suitable to that scene. Also, training the DNN requires a large volume of carefully annotated data. Moreover, a DNN trained for one scenario may not scale well to other scenarios. For example, autonomous driving scenarios are very different from Augmented Reality (AR)\Virtual Reality (VR) scenarios. Thus, it is advantageous to optimize the Spot ToF power utilization, since such optimization allows for higher frame rates and longer usage time before recharging a portable device. Also, it is advantageous to have a Spot ToF that scales well to unseen scenarios and does not require retraining.

### SUMMARY

According to an aspect of one or more embodiments, there is provided a method comprising receiving, by a sampling system, one or more images of a scene captured using a Complementary Metal Oxide Semiconductor (CMOS) Image Sensor (CIS) camera; dividing, by the sampling system, each of the one or more images into a plurality of rectangular regions, based on an edge feature identified in the one or more images; computing, by the sampling system, an edge region alignment for each of the plurality of rectangular regions by analyzing a Histogram of oriented Gradients (HoG) distribution corresponding to each of the plurality of rectangular regions; re-projecting, by the sampling system, Time of Flight (ToF) data on a CIS image plane according to the edge region alignment and a directional sampling filter for computing a regional depth variance; sampling, by the sampling system, one or more rectangular regions from among the plurality of rectangular regions by comparing the regional depth variance with a threshold depth variance; and dynamically reconfiguring, by the sampling system, an illumination pattern for a spot ToF sensor image frame using the one or more rectangular regions that are sampled, for reconstructing a three dimensional (3D) model of the scene.

According to another aspect of one or more embodiment, there is provided a sampling system comprising a processor, and a memory communicatively coupled to the processor, the memory storing processor-executable instructions which when accessed and executed by the processor causes the processor to receive one or more images of a scene captured using a Complementary Metal Oxide Semiconductor (CMOS) Image Sensor (CIS) camera; divide each of the one or more images into a plurality of rectangular regions, based on an edge feature identified in the one or more images; compute an edge region alignment for each of the plurality of rectangular regions by analyzing a Histogram of oriented Gradients (HoG) distribution corresponding to each of the plurality of rectangular regions; re-project Time of Flight (ToF) data on a CIS image plane according to the edge region alignment and a directional sampling filter for computing a regional depth variance; sample one or more rectangular regions from among the plurality of rectangular regions by comparing the regional depth variance with a threshold depth variance; and dynamically reconfigure an illumination pattern for a spot ToF sensor image frame using the one or more rectangular regions that are sampled, for reconstructing a 3D model of the scene.

According to another aspect of one or more embodiment, there is provided a method comprising receiving, by a processor, an image of a scene; dividing, by the processor, the image into a plurality of rectangular regions, based on an edge feature in the image; computing, by the processor, an edge region alignment for each rectangular region by analyzing a Histogram of oriented Gradients (HoG) distribution corresponding to the rectangular region; re-projecting, by the processor, Time of Flight (ToF) data on a Complementary Metal Oxide Semiconductor (CMOS) Image Sensor (CIS) image plane according to the edge region alignment; sampling, by the processor, one or more rectangular regions from among the plurality of rectangular regions by comparing a regional depth variance of each rectangular region with a threshold depth variance; and reconfiguring, by the processor, an illumination pattern for a spot ToF sensor image frame using the one or more rectangular regions that are sampled.

### BRIEF DESCRIPTION OF THE DRAWINGS

The above and/or other aspects will become apparent and more readily appreciated from the following description of various embodiments, taken in conjunction with the accompanying drawings, in which:

FIG. 1 shows an exemplary overview of an arrangement for optimizing sampling in a spot Time-of-Flight (ToF) sensor, in accordance with some embodiments;

FIG. 2 shows a detailed block diagram of a sampling system for optimizing sampling in a spot Time-of-Flight (ToF) sensor, in accordance with some embodiments;

FIG. 3 is a flow diagram showing an exemplary method for optimizing sampling in a spot Time-of-Flight (ToF) sensor, in accordance with some embodiments;

FIG. 4 illustrates a flow diagram of configuring illumination patterns for a spot-ToF frame using Complementary Metal Oxide Semiconductor (CMOS) Image Sensor (CIS) data, in accordance with another embodiment;

FIG. 5A illustrates an RGB image of a scene that is captured by spot-ToF, in accordance with some embodiments;

FIG. 5B illustrates uniform down-sampling by retaining every K^{th} sample from indirect flood ToF, in accordance with some embodiments;

FIG. 5C illustrates a voxel down-sampling of flood ToF generated by a current spot-ToF module, in accordance with some embodiments;

FIG. 5D illustrates non-uniform sampling based on edge map before removing two-dimensional (2D) edges, in accordance with some embodiments;

FIG. 5E shows a flood ToF depth image, and an edge-based sample pattern after removing 2D edges from the flood ToF depth image, in accordance with some embodiments;

FIG. 6 illustrates patterns of directional sampling filters, in accordance with some embodiments; and

FIG. 7 illustrates a block diagram of an exemplary computer system for implementing various embodiments consistent with the present disclosure.

### DETAILED DESCRIPTION

The accompanying drawings, which are incorporated in and constitute a part of the present disclosure, illustrate exemplary embodiments and, together with the description, explain principles consistent with the present disclosure. The same reference numbers are used throughout the figures to reference like features and components.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in a computer readable medium which, when accessed and executed by a computer or processor, cause the computer or processor to execute the various processes represented in the flow chart, flow diagrams, state transition diagrams, pseudo code and the like.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiments thereof has been shown by way of example in the drawings and will be described in detail below. It should be understood, however that these specific embodiments are not intended to limit the disclosure to the specific forms disclosed, but on the contrary, the disclosure is to cover all modifications, equivalents, and alternative falling within the scope of the disclosure and claims.

The terms “comprise”, “comprising”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The terms “include”, “including”, or any other variations thereof, are intended to cover a non-exclusive inclusion, such that a setup, device, or method that includes a list of components or steps does not include only those components or steps but may include other components or steps not expressly listed or inherent to such setup or device or method. In other words, one or more elements in a system or apparatus proceeded by “includes . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure and claims. The following description is, therefore, not to be taken in a limiting sense.

The present disclosure relates to a method and a sampling system for optimizing sampling in a spot Time-of-Flight (ToF) sensor using CMOS Image Sensor (CIS) data. The method is configured to receive one or more images of a scene from an image capturing device using a CIS camera. After receiving the scene (for example, a 3-Dimension (3D) scene) from an image capturing device, the method is configured to determine a scene structure by dividing each of the one or more images into a plurality of rectangular regions of a certain size. The certain size may be predetermined. Once the scene structure is determined, the method is configured to compute an edge region alignment for each of the plurality of rectangular regions by analyzing a Histogram of oriented Gradients (HoG) distribution for establishing a sampling kernel. Thereafter, the method is configured to re-project ToF data on a CIS image plane according to the edge region alignment and apply an appropriate directional sampling filter for computing a regional depth variance. Once the regional depth variance is computed, the method is configured to sample one or more rectangular regions from the scene structure by comparing the regional depth variance with a threshold depth variance. Based on a comparison between the regional depth variance and a threshold, rectangular regional samples are removed (on the identification of a 2-Dimension (2D) edge) or rectangular regional samples are accumulated (on the identification of a 3D edge). Further, the method is configured to dynamically reconfigure an illumination pattern for the spot ToF sensor image frame using a filtered sampled scene structure for reconstructing a 3D model of the scene.

In this manner, methods, devices, and systems consistent with the present disclosure optimizes sampling in a spot Time-of-Flight (ToF) sensor using CMOS Image Sensor (CIS) data, which in turn reduces power consumption on every active sampling. In addition, the method may be implemented to function with low-power mobile devices by utilizing straightforward image features such as edges of objects.

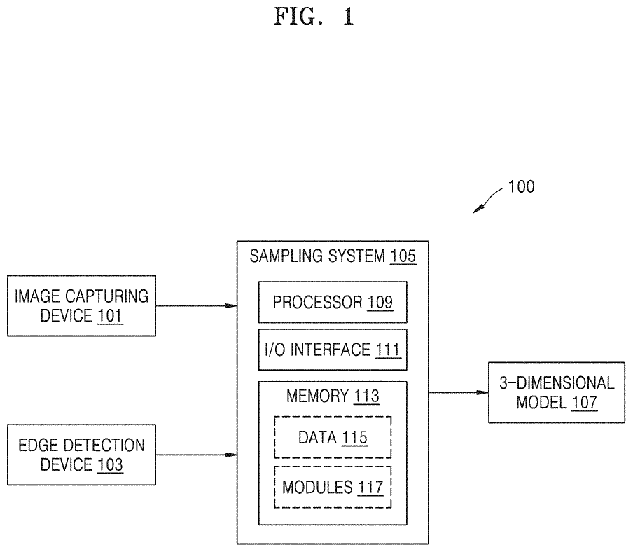

FIG. 1 shows an exemplary overview of an arrangement used for optimizing sampling in a spot Time-of-Flight (ToF) sensor, in accordance with some embodiments

In an embodiment, an exemplary environment 100 may include, without limitation, an image capturing device 101, an edge detection device 103, a sampling system 105 and a three-Dimensional (3D) model 107. The sampling system 105 comprises a processor 109, an input/output (I/O) Interface 111 and a memory 113. The processor 109 may interface with the memory 113 and may be configured for performing one or more functions of the sampling system 105 while optimizing the sampling in the spot Time-of-Flight (ToF) sensor. The I/O Interface 111 may be configured for receiving one or more images of a scene from the image capturing device 101. The memory 113 may also store data 115 and modules 117 of the sampling system 105.

The Time-of-Flight (ToF) technique is an active imaging technique, which provides a distance between the camera and an object. There are two techniques in ToF, namely Direct ToF (dToF) and Indirect ToF (iToF). In the iToF method, sensors assess the depth from phase-delay. In the direct ToF method, the sensors measure the depth from the time-delay between emitted and received light pulses.

In an embodiment, the iToF may be used with Flood iToF (for example, continuous samples) or spot iToF (for example, discrete samples). The spot-ToF sensor comprises a full-resolution Flood ToF which is present at the front end of the system and a spot ToF module that emits high-power Light Amplification by Simulated Emission of Radiation (LASER) light for accurate depth at a set of sample points. For example, a 640×480 pixels Flood ToF canvas may comprise 700 sample points.

In an embodiment, the image capturing device 101 may be configured for capturing one or more images of a scene. As an example, the image capturing device 101 may be, without limitation, a Complementary Metal-Oxide-Semiconductor (CMOS) Image Sensor (CIS). In some embodiments, the image capturing device 101 may be used as an intermediate storage for receiving and storing the one or more images of the scene from other image capturing devices (not shown in FIG. 1).

In an embodiment, the sampling system 105 may receive the one or more images from the image capturing device 101 and divide each of the one or more images into a plurality of rectangular regions of a certain size, based on an edge feature identified in the one or more images. For example, a 3D scene image obtained from a CIS sensor edge map may be divided into rectangular regions of dimension 32×32 pixels. Region-based edge features of the CIS camera may be used for identifying a scene structure. After dividing each of the one or more images, an edge region alignment may be computed based on the Histogram of Oriented Gradients (HOG) distribution for determining a sampling kernel. For example, the edge region alignment may be computed using HoG values segregated in bins corresponding to a 0° alignment, a 45° alignment, a 90° alignment, and a 135° alignment. Furthermore, the ToF data may be re-projected onto a CIS image plane based on edge region alignment and by using a suitable primitive/directional sampling filter to calculate regional depth variance. The directional sampling filters may include a horizontal direction filter, a vertical direction filter, a circular filter, a diagonal direction filter and an anti-diagonal direction.

In an embodiment, the iToF depth on the CIS edge map may be re-projected for computing regional depth variance (e.g., S_{D}) around the edges. The 2D edges may be filtered based on a comparison between neighborhood depth variance and a Threshold (TH). Sampling may be applied on one or more rectangular regions from the scene structure by comparing the regional depth variance with a threshold depth variance. Thereafter, one or more rectangular regions with two-Dimensional (2D) edges and one or more rectangular regions with 3D edges may be identified after sampling the one or more rectangular regions. Once the regional depth variance is compared, if the depth variance is less than the threshold value (S_{D}<TH), the regional samples on the identification of the 2D edge are removed. On the other hand, when the depth variance is equal to or exceeds the threshold value, the samples on 3D edge identification are accumulated. Further, the illumination pattern for spot ToF frame is re-configured based on re-projected filtered samples for reconstructing a 3D model 107 of the scene.

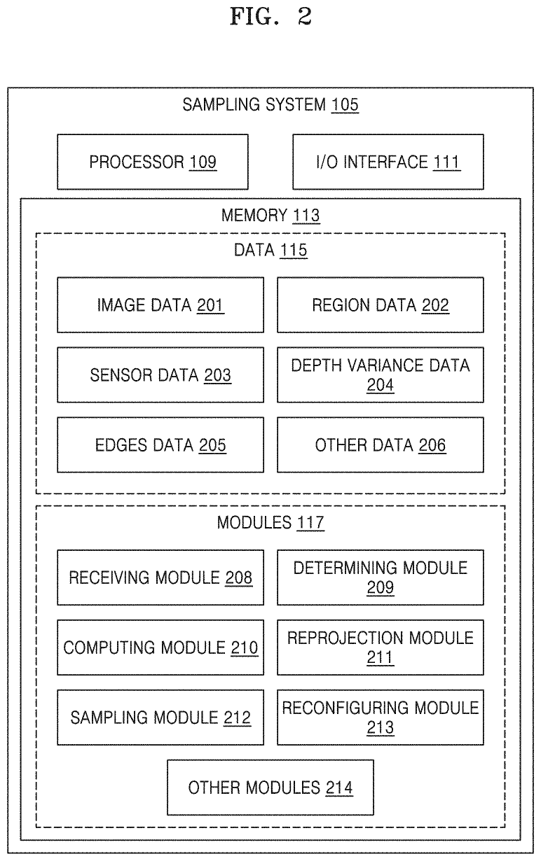

FIG. 2 shows a detailed block diagram of a sampling system for optimizing sampling in a spot Time-of-Flight (ToF) sensor, in accordance with some embodiments.

In some implementations, the sampling system 105 receives data 115 through the I/O interface 111. The received data 115 is stored within the memory 113. In an embodiment, the data 115 stored in the memory 113 may include, without limitation, data 115 related to one or more images 201 (or image data 201), region data 202, sensor data 203, depth variance data 204, edges data 205 and other data 206 associated with the sampling system 105.

In one embodiment, the data 115 may be stored in memory 113 in the form of various data structures. Additionally, the data 115 may be organized using data models, such as relational or hierarchical data models. The other data 206 may store data, including various temporary data and temporary files, generated by modules 117 for performing the various functions of the sampling system 105. As an example, the other data 206 may include, without limitation, temporarily stored previous input data or stored data collected from the various images.

In an embodiment, the image data 201 comprises one or more images of a scene. The images may be captured in an indoor environment or an outdoor environment. The captured images may include, without limitation, High-Definition (HD) images, Red Green Blue (RGB) color images, or hyperspectral images. The image data 201 may also contain historic images of the scene obtained under various environmental conditions.

In an embodiment, the region data 202 may be the raw data obtained by dividing the one or more images into a plurality of rectangular regions. In some embodiments, the rectangular regions may be of small discrete pixels. The rectangular regions may be of a size that is predetermined. As an example, in some embodiments, the size of each of the rectangular regions may be 32×32 pixels.

In an embodiment, the sensor data 203 may comprise data obtained from various sensors including the Spot ToF sensor, CMOS image sensor and the like. Data generated and captured with the spot ToF sensors may be used to estimate the depth of the 3D scene. ToF depth sensor devices enable the sampling system 105 to easily retrieve scene depth data with high frame rates.

In an embodiment, the depth variance data 204 may contain both regional depth variance and threshold depth variance data. Variance distribution in a depth image may be taken at an average distance from a scene. and the depth may contain a large amount of noise near the corners of the image. The threshold depth variance is determined by analyzing each of the one or more images of the scene.

In an embodiment, the edges data 205 comprises information related to the 2D edges and the 3D edges of the captured images. The edge of an object is a feature used to determine the shapes, positions, or size of the object. The 2D edges are identified when the regional depth variance is less than the threshold depth variance, wherein the threshold depth variance is determined by how aggressively the 2D edges are pruned, and the threshold depth variance may be tuned to achieve a desired output sampling density. The 3D edges are identified when the regional depth variation is equal to or more than the threshold depth variance.

In an embodiment, the data 115 stored in memory 113 may be processed by one or more modules 117 of the sampling system 105. The modules 117 may be stored within the memory 113 as shown in FIG. 2. In an embodiment, the one or more modules 117 may be implemented as dedicated hardware and when implemented as hardware, said modules 117 may be configured with the functionality defined in the present disclosure to result in a novel hardware. As used herein, the term “module” may refer to an Application Specific Integrated Circuit (ASIC), an electronic circuit, a Field-Programmable Gate Arrays (FPGA), Programmable System-on-Chip (PSoC), a combinational logic circuit, and/or other suitable components that are adapted to provide the described functionality. For example, an ASIC may be adapted to implement a re-configuring module 213 (described below) and thus may become a re-configuration ASIC. In an example, the modules 117, communicatively coupled to the processor 109, may also be present outside the memory 113.

In one implementation, the modules 117 may include, for example, a receiving module 208, a determining module 209, a computing module 210, a re-projection module 211, a sampling module 212, a reconfiguring module 213, and other modules 214. The other modules 214 may be used to perform various miscellaneous functionalities of the sampling system 105. It will be appreciated that such aforementioned modules 117 may be represented as a single module or a combination of different modules 117.

In an embodiment, the receiving module 208 may be configured to receive one or more images of a scene captured using a Complementary Metal Oxide Semiconductor (CMOS) Image Sensor (CIS) camera. The receiving module 208 may also be configured to select an appropriate edge detection technique used for detecting edges in the one or more images, from an edge detection device 103 associated with the sampling system 105 (see FIG. 1). As an example, the edge detection technique may include, without limitation, a canny edge detection technique or a sobel edge detection technique, which are used to extract the edge features from the one or more images.

In an embodiment, the determining module 209 may be configured to determine a scene structure by dividing each of the one or more images. For example, the one or more images may be divided into a plurality of rectangular regions, based on an edge feature. For example, the rectangular regions may be of a size that is predetermined. For example, in some embodiments, the size of each of the plurality of rectangular regions may be 32×32 pixels for an RGB image of a scene.

In an embodiment, the computing module 210 may be configured to compute an edge region alignment for each of the plurality of rectangular regions. By analyzing a Histogram of oriented Gradients (HoG) distribution corresponding to each of the plurality of rectangular regions, the computing module 210 may compute an edge region alignment. Further, the edge region alignment values may be segregated into 4 bins, each bin corresponding, respectively, to a 0° alignment, a 45° alignment, a 90° alignment, and a 135° alignment.

In an embodiment, the re-projection module 211 may be configured to re-project ToF data on a CIS image plane according to the edge region alignment. The re-projection module 211 may also be configured to compute a regional depth variance after applying a primitive directional sampling filter to a scene.

In an embodiment, the sampling module 212 may be configured to sample one or more rectangular regions from the scene structure by comparing the regional depth variance with a threshold depth variance. The sampling module 212 may also be configured to identify one or more rectangular regions with two-Dimensional (2D) edges and one or more rectangular regions with three-Dimensional (3D) edges. Further, the 2D edges are eliminated when the regional depth variance is less than the threshold depth variance.

In an embodiment, the reconfiguring module 213 may be configured to dynamically reconfigure an illumination pattern for the spot ToF sensor image frame. The reconfiguration may be performed based on re-projected filtered samples for reconstructing a 3D model 107 of the scene.

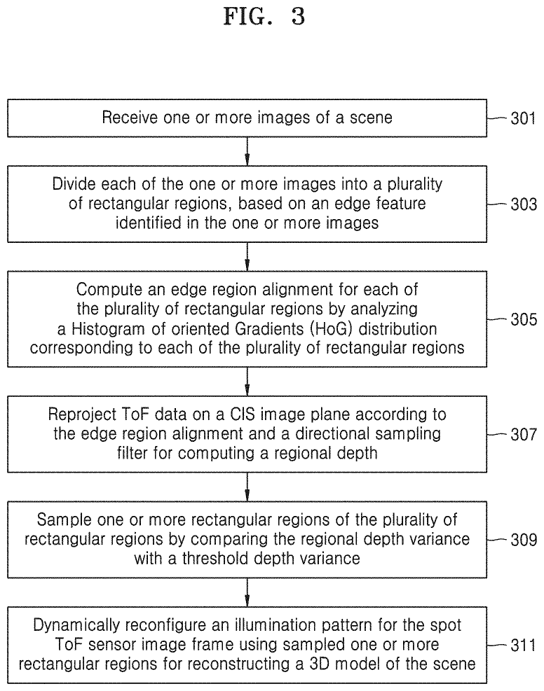

FIG. 3 is a flow diagram showing an exemplary method for optimizing sampling in a spot Time-of-Flight (ToF) sensor, in accordance with some embodiments.

As illustrated in FIG. 3, the method comprises one or more blocks for optimizing sampling in operation in a sampling system 105. The method may be described in the general context of computer executable instructions or computer program code. Generally, computer executable instructions may include routines, programs, objects, components, data structures, procedures, modules, and functions, which perform particular functions or implement particular abstract data types.

The order in which the method is described is not intended to be construed as a limitation, and any number of the described method blocks may be combined in any order to implement the method. Additionally, individual blocks may be deleted from the methods without departing from the spirit and scope of the claims and the subject matter described herein. Furthermore, the method may be implemented in any suitable hardware, software, firmware, or combination thereof.

At block 301, the method comprises receiving, by a sampling system 105, one or more images of a scene. In some embodiments, the one or more images may be captured using a Complementary Metal Oxide Semiconductor (CMOS) Image Sensor (CIS) camera. As an example, one or more images of a scene (e.g., a 3D scene) may be captured by the image capturing device 101 and obtained at the initial stage of the sampling process. The one or more images of the scene may vary based on whether the image is captured in an indoor environment or an outdoor area.

At block 303, the method comprises dividing, by the sampling system 105, each of the one or more images into a plurality of rectangular regions. For example, each of the one or more images may be divided into the plurality of rectangular regions to determine a scene structure. The rectangular regions may be of a predetermined size. For example, in some embodiments, the size of each of the plurality of rectangular regions may be 32×32 pixels which are based on an edge feature identified in the one or more images.

At block 305, the method comprises computing, by the sampling system 105, an edge region alignment for each of the plurality of rectangular regions by analyzing a Histogram of oriented Gradients (HoG) distribution corresponding to each of the plurality of rectangular regions. The edge region alignment may be computed using HoG values segregated into a plurality of bins, wherein the bins correspond, respectively, to a 0° alignment, a 45° alignment, a 90° alignment, and a 135° alignment.

At block 307, the method comprises re-projecting, by the sampling system 105, ToF data on a CIS image plane according to the edge region alignment and a directional sampling filter for computing a regional depth variance.

At block 309, the method comprises sampling, by the sampling system 105, one or more rectangular regions of the plurality of rectangular regions by comparing the regional depth variance with a threshold depth variance. For example, in some embodiments, the one or more rectangular regions of the plurality of rectangular regions may be sampled by comparing the regional depth variance of each of the plurality of rectangular regions with a threshold depth variance. Filtering 2D edges from the 3D edges may be performed based on the comparison between neighborhood depth variance and the threshold depth variance.

At block 311, the method comprises dynamically reconfiguring, by the sampling system 105, an illumination pattern for the spot ToF sensor image frame using sampled one or more rectangular regions for reconstructing a 3D model 107 of the scene with low-power active sampling. For example, reconfiguring the illumination pattern for the Spot ToF frame may be performed based on explicit scene structure (i.e., depth-discontinuities).

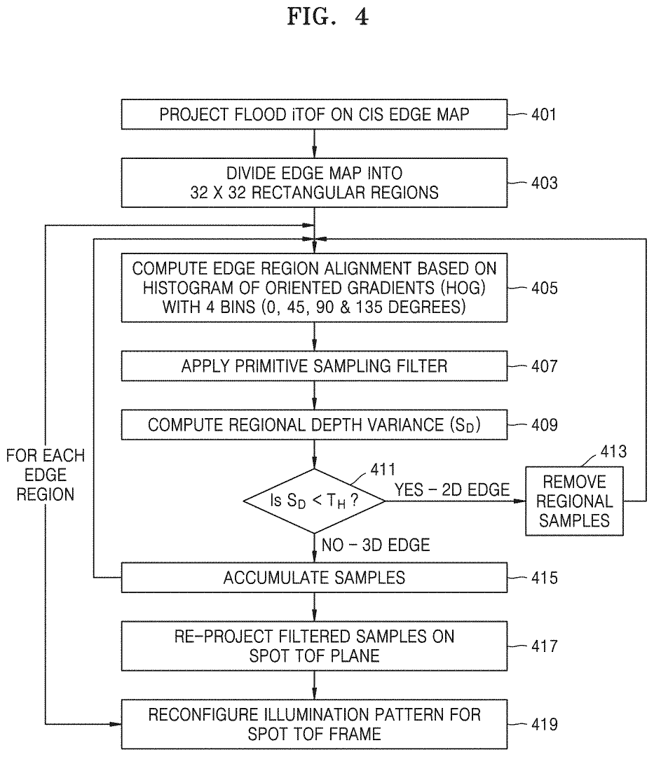

FIG. 4 illustrates a flow diagram of configuring illumination patterns for a spot-ToF frame using CIS data, in accordance with another embodiment.

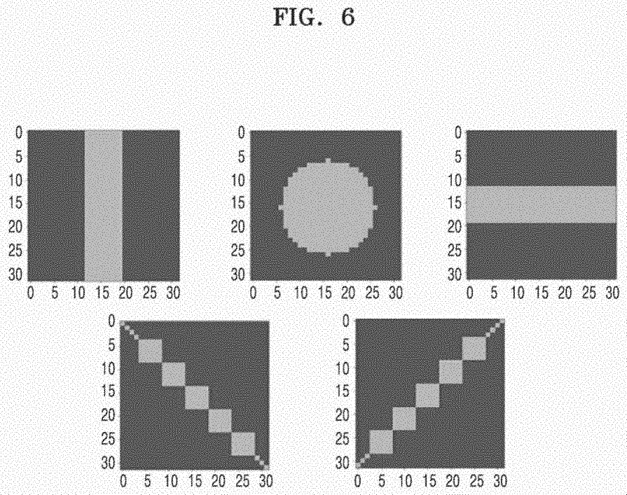

At block 401, the one or more images of the scene are projected with flood iToF on a CIS edge map. At block 403, the obtained edge map from a CIS sensor may be divided into a plurality of rectangular regions of size 32×32 pixels to determine the scene structure. At block 405, the method computes an edge region alignment based on HoG distribution with 4 bins with an alignment of, for example, 0° alignment, a 45° alignment, a 90° alignment, and a 135° alignment, respectively. At block 407, a primitive sampling filter is applied on the computed edge region alignment. For example, for the resulting sampled locations, a primitive/directional sampling filter with regard to horizontal, vertical, circular, and diagonal directions may be applied as shown in FIG. 6. After applying the directional sampling filter, regional depth variance (S_{D}) may be computed at block 409. Further, at block 411, the method compares the regional depth variance with a Threshold depth variance (TH). Once the regional depth variance is compared, and the depth variance is less than the threshold value (i.e., S_{D}<Th) (block 411, YES), the regional samples on the identification of the 2D edge are removed at block 413. On the other hand, when the depth variance is equal to or greater than the threshold value (block 411, NO), the 3D edge samples are identified and accumulated at block 415. Once the 3D samples are accumulated, at block 417, the filtered samples are re-projected on the Spot ToF data on CIS image plane according to the edge region alignment. The illumination pattern for the spot ToF frame is re-configured based on re-projected filtered samples for 3D reconstructing a 3D model 107 at block 419.

### Exemplary Scenario:

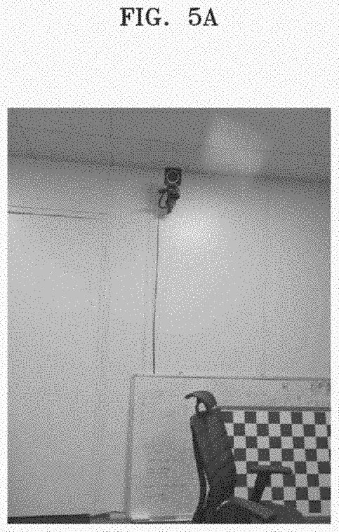

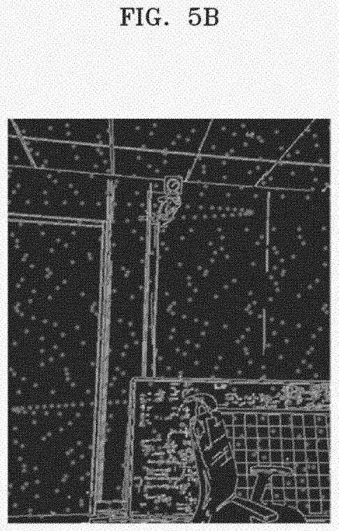

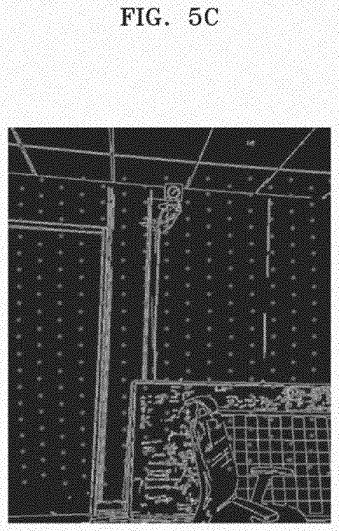

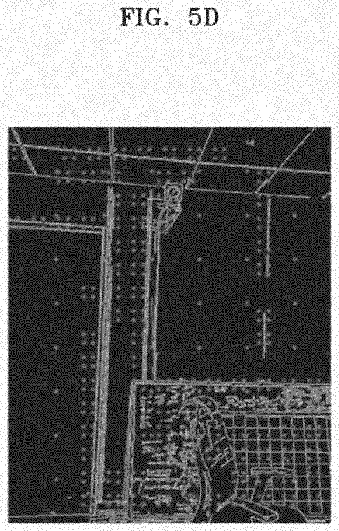

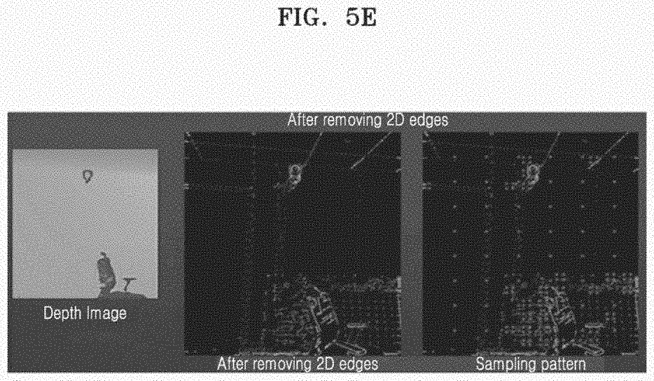

As shown in FIG. 5A, consider an RGB image of a scene, for example, an indoor scene image, and in particular, an inside area of an office room, which contains a chair, a checkerboard, a whiteboard, and a camera mounted on the wall, which scene is captured by a spot-ToF camera. Here, a uniform down-sampling may be applied on the image by retaining every K^{th} sample from indirect flood ToF (for example, total 700 points) of the image, as shown in FIG. 5B. According to uniform downsampling, each occurrence of a data set has the same probability of being included in the smaller data set. Further, a voxel down-sampling of flood ToF generated by the current spot-ToF module (for example, 400 points) may be obtained, as shown in FIG. 5C. In an embodiment, to reduce computation time, the voxel-grid filter may be used to downsample point clouds. Filtering is accomplished by constructing a 3D voxel grid, which resembles a stack of small boxes. A point approximation is performed in each voxel, either by averaging all points in the voxel or by approximating a point at the voxel's center. FIG. 5D illustrates performing edge map based non-uniform sampling before removing the 2D edges from the sampled image. Once the regional depth variance is compared, and the depth variance is less than the threshold value (i.e., S_{D}<Th), the regional samples on the identification of the 2D edge are removed along with sampling pattern, as shown in FIG. 5E.

In an embodiment, the 3D reconstruction from Point Cloud Data (PCD) may be processed using an Open3D reference algorithm applied on sub-sampled PCDs. For example, consider Samsung's Azure Kinect dataset, where a sequence of frames consists of 472 RGB-Depth (RGBD) frames each of size 540×720 pixels, in a room containing monitors, cabinets, chairs, and boards. The Kinect Azure device supports the highest RGB resolution among other comparison cameras. The accuracy may be measured by measuring the inaccuracy along the X, Y, and Z axes and the mean latency of proposed blocks is 39.17 ms per frame (i.e., ˜1 frame delay @ 30 fps). The results on the Samsung Azure Kinect dataset are tabulated in Table 1 below.

TABLE 1

| Sl. | | Mean No. | Total |
|---|---|---|---|
| No | Configuration | of Samples | Error (%) |
| 1 | Uniformly down sampled flood point | 267 | 3.11 |
| | clouds (Spot-ToF baseline) | | |
| 2 | Point clouds generated by the present | 262 | 2.78 |
| | invention | | |

In an embodiment, a dataset from Imperial College London and National University of Ireland Maynooth (ICL-NUIM) office dataset may be considered for evaluation of 3D reconstruction, where an “office room” sequence is 0 and consists of 1508 RGB-D frames (RGB-Depth) each of size 640×480 pixels. The ICL-NUIM dataset consists of handheld RGB-D camera sequences captured in synthetically produced situations. To accurately assess the correctness of a specific image, these sequences were shot in a living room and an office area with precise ground-truth positions. The mean latency of the proposed blocks is 36.97 ms per frame (i.e., ˜1 frame delay @ 30 fps). The results on ICL-NUIM Office 0 dataset are tabulated in Table 2 below.

TABLE 2

| Sl. | | Mean No. | Total |
|---|---|---|---|
| No | Configuration | of Samples | Error (%) |
| 1 | Uniformly down-sampled flood point | 432 | 3.71 |
| | clouds (Spot-ToF baseline) | | |
| 2 | Point-clouds generated by the present | 441 | 1.64 |
| | invention | | |

In an embodiment, the final latency may be much lower with optimization and running on a hardware accelerator or ASIC. Hence, the spot-ToF sensing with high accuracy may be useful in applications such as augmented reality, mixed reality 3D gaming, 3D reconstruction and multi-view rendering of objects, measuring the physical world through image sensors on phones, and autonomous driving.

### Computer System

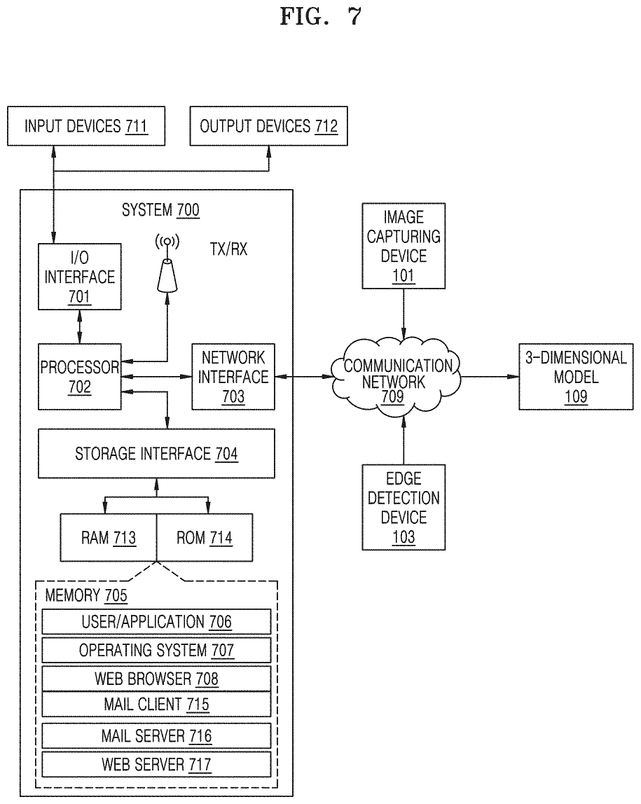

FIG. 7 illustrates a block diagram of an exemplary computer system 700 for implementing embodiments consistent with the present disclosure. In an embodiment, the computer system 700 may be the sampling system 105 which may be used for optimizing sampling in spot Time-of-Flight (ToF) sensor. The computer system 700 may include a processor 702 (for example, a central processing unit (CPU) or microprocessor). The processor 702 may comprise at least one data processor for executing program components for executing user or system-generated business processes. The processor 702 may include specialized processing units such as integrated system (bus) controllers, memory management control units, floating point units, graphics processing units, digital signal processing units, etc.

The processor 702 may be disposed in communication with one or more input/output (I/O) devices (711 and 712) via I/O interface 701. The I/O interface 701 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc. Using the I/O interface 701, the computer system 700 may communicate with one or more I/O devices 711 and 712. The computer system 700 may receive data from image capturing device 101 and edge detection device 103.

In some embodiments, the processor 702 may be disposed in communication with a communication network 709 via a network interface 703. The network interface 703 may communicate with the communication network 709. The network interface 703 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc.

The communication network 709 may be implemented as one of the several types of networks, such as intranet or Local Area Network (LAN) and such within the organization. The communication network 709 may either be a dedicated network or a shared network, which represents an association of several types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 709 may include a variety of network devices, including routers, bridges, servers, computing devices, storage devices, etc.

In some embodiments, the processor 702 may be disposed in communication with a memory 705 (e.g., RAM 713, ROM 714, etc. as shown in FIG. 7) via a storage interface 704. The storage interface 704 may connect to memory 705 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 705 may store a collection of program or database components, including, without limitation, user/application 706, an operating system 707, a web browser 708, mail client 715, mail server 716, web server 717 and the like. In some embodiments, computer system 700 may store user/application data 706, such as the data, variables, records, etc. as described in this invention. Such databases may be implemented as fault-tolerant, relational, scalable, secure databases such as Oracle® or Sybase®.

The operating system 707 may facilitate resource management and operation of the computer system 700. Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS' (E.G., RED HAT™, UBUNTU™, KUBUNTU™, etc.), IBM™ OS/2, MICROSOFT™ WINDOWS™ (XP™ VISTA™/7/8, 10 etc.), APPLE® IOS™ GOOGLE® ANDROID™, BLACKBERRY® OS, or the like. A user interface may facilitate display, execution, interaction, manipulation, or operation of program components through textual or graphical facilities. For example, user interfaces may provide computer interaction interface elements on a display system operatively connected to the computer system 400, such as cursors, icons, check boxes, menus, windows, widgets, etc. Graphical User Interfaces (GUIs) may be employed, including, without limitation, APPLE MACINTOSH® operating systems, IBM™ OS/2, MICROSOFT™ WINDOWS™ (XP™, VISTA™/7/8, 10 etc.), Unix® X-Windows, web interface libraries (e.g., AJAX™, DHTML™, ADOBE® FLASH™ JAVASCRIPT™, JAVA™, etc.), or the like.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

In an embodiment, the present disclosure provides a method and system for optimizing sampling in spot Time-of-Flight (ToF) sensor using CIS data.

In an embodiment, the present disclosure may operate with a low-power mobile device using primitive image features.

In an embodiment, the present disclosure may distinguish 2D edges from 3D edges and reconfigure the illumination pattern of a Spot-ToF sensor to sample near-depth discontinuities.

In an embodiment, the present disclosure may reduce total power consumption with higher frame rates and may not require prior training because the features of the dataset are not learned from the sample dataset.

In an embodiment, the present disclosure may make augmented reality and virtual reality consumer experiences more realistic and user friendly, which increases accessibility.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments consistent with the present disclosure.

When a single device or article is described herein, it will be clear that more than one device/article (whether they cooperate) may be used in place of a single device/article. Similarly, where more than one device or article is described herein (whether they cooperate), it will be clear that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the subject matter. It is therefore intended that the scope of the present disclosure be limited not by this detailed description, but rather by any claims that issue on an application based here on. Accordingly, the embodiments are intended to be illustrative, but not limiting, of the scope, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method comprising:
receiving, by a sampling system, one or more images of a scene captured using a Complementary Metal Oxide Semiconductor (CMOS) Image Sensor (CIS) camera;
dividing, by the sampling system, each of the one or more images into a plurality of rectangular regions, based on an edge feature identified in the one or more images;
computing, by the sampling system, an edge region alignment for each of the plurality of rectangular regions by analyzing a Histogram of oriented Gradients (HoG) distribution corresponding to each of the plurality of rectangular regions;
re-projecting, by the sampling system, Time of Flight (ToF) data on a CIS image plane according to the edge region alignment and a directional sampling filter for computing a regional depth variance;
sampling, by the sampling system, one or more rectangular regions from among the plurality of rectangular regions by comparing the regional depth variance with a threshold depth variance; and
dynamically reconfiguring, by the sampling system, an illumination pattern for a spot ToF sensor image frame using the one or more rectangular regions that are sampled, for reconstructing a three dimensional (3D) model of the scene.

2. The method as claimed in claim 1, wherein the edge feature is extracted from the one or more images using at least one of a canny edge detection technique or a sobel edge detection technique.

3. The method as claimed in claim 1, wherein a size of each of the plurality of rectangular regions is 32×32 pixels.

4. The method as claimed in claim 1, wherein sampling the one or more rectangular regions comprises:
identifying, by the sampling system, one or more first rectangular regions among the plurality of rectangular regions that has two dimensional (2D) edges and one or more second rectangular regions among the plurality of rectangular regions that has three dimensional (3D) edges; and
eliminating, by the sampling system, the one or more first rectangular regions.

5. The method as claimed in claim 4, wherein the 2D edges are identified when the regional depth variance is less than the threshold depth variance, and
wherein the 3D edges are identified when the regional depth variance is equal to or greater than the threshold depth variance.

6. The method as claimed in claim 1, wherein the threshold depth variance is determined by analyzing images captured in an indoor scene and an outdoor scene.

7. The method as claimed in claim 1, wherein the edge region alignment is computed using HoG values segregated in bins corresponding, respectively, to a 0° alignment, a 45° alignment, a 90° alignment and a 135° alignment.

8. A sampling system comprising:
a processor; and
a memory communicatively coupled to the processor, the memory storing processor-executable instructions which when accessed and executed by the processor causes the processor to:
receive one or more images of a scene captured using a Complementary Metal Oxide Semiconductor (CMOS) Image Sensor (CIS) camera;
divide each of the one or more images into a plurality of rectangular regions, based on an edge feature identified in the one or more images;
compute an edge region alignment for each of the plurality of rectangular regions by analyzing a Histogram of oriented Gradients (HoG) distribution corresponding to each of the plurality of rectangular regions;
re-project Time of Flight (ToF) data on a CIS image plane according to the edge region alignment and a directional sampling filter for computing a regional depth variance;
sample one or more rectangular regions from among the plurality of rectangular regions by comparing the regional depth variance with a threshold depth variance; and
dynamically reconfigure an illumination pattern for a spot ToF sensor image frame using the one or more rectangular regions that are sampled, for reconstructing a 3D model of the scene.

9. The sampling system as claimed in claim 8, wherein the processor extracts the edge feature from the one or more images using at least one of a canny edge detection technique or a sobel edge detection technique.

10. The sampling system as claimed in claim 8, wherein a size of each of the plurality of rectangular regions is 32×32 pixels.

11. The sampling system as claimed in claim 8, wherein the processor samples the one or more rectangular regions by:
identifying one or more first rectangular regions among the plurality of rectangular regions that has two dimensional (2D) edges and one or more second rectangular regions among the plurality of rectangular regions that has (3D) edges; and
eliminating the one or more first rectangular regions.

12. The sampling system as claimed in claim 11, wherein the processor identifies the 2D edges when the regional depth variance is less than the threshold depth variance, and identifies the 3D edges when the regional depth variance is equal to or greater than the threshold depth variance.

13. The sampling system as claimed in claim 11, wherein the processor determines the threshold depth variance by analyzing images captured in an indoor scene and an outdoor scene.

14. The sampling system as claimed in claim 8, wherein the processor computes the edge region alignment by using HoG values segregated in bins corresponding, respectively, to a 0° alignment, a 45° alignment, a 90° alignment and a 135° alignment.

15. A method comprising:
receiving, by a processor, an image of a scene;
dividing, by the processor, the image into a plurality of rectangular regions, based on an edge feature in the image;
computing, by the processor, an edge region alignment for each rectangular region by analyzing a Histogram of oriented Gradients (HoG) distribution corresponding to the rectangular region;
re-projecting, by the processor, Time of Flight (ToF) data on a Complementary Metal Oxide Semiconductor (CMOS) Image Sensor (CIS) image plane according to the edge region alignment;
sampling, by the processor, one or more rectangular regions from among the plurality of rectangular regions by comparing a regional depth variance of each rectangular region with a threshold depth variance; and
reconfiguring, by the processor, an illumination pattern for a spot ToF sensor image frame using the one or more rectangular regions that are sampled.

16. The method as claimed in claim 15, wherein the image of the scene is captured by a CIS camera.

17. The method as claimed in claim 15, wherein the edge feature is extracted from the image using at least one of a canny edge detection technique or a sobel edge detection technique.

18. The method of claim 15, wherein, after re-projecting the ToF data, the method further comprises applying a directional sampling filter for computing the regional depth variance.

19. The method as claimed in claim 1, wherein sampling the one or more rectangular regions comprises:
identifying, by the processor, one or more first rectangular regions among the plurality of rectangular regions that has two dimensional (2D) edges and one or more second rectangular regions among the plurality of rectangular regions that has three dimensional (3D) edges; and
eliminating, by the sampling system, the one or more first rectangular regions.

20. The method as claimed in claim 1, wherein the edge region alignment is computed using HoG values segregated in bins corresponding, respectively, to a 0° alignment, a 45° alignment, a 90° alignment and a 135° alignment.
